(19) United States
(12) Patent Application Publication
(10) Pub. No.: US 2024/0272119 A1
(43) Pub. Date: Aug. 15, 2024

(54) Radon Gas Detector with Integrated Collection and Processing Functionality

(71) Applicant: LIMIN ZHANG, SEATTLE, WA (US)

(72) Inventor: LIMIN ZHANG, SEATTLE, WA (US)

(21) Appl. No.: 18/444,630

(22) Filed: May 3, 2024

(51) Int. Cl. G01N 27/62

(52) U.S. Cl. CPC G01N 27/62

(57) ABSTRACT

A radon gas detector with integrated collection and processing functionality is presented. The detector features an injection-mode produced plastic semi-enclosed vented ion chamber, facilitating simplified manufacturing processes and reduced production costs. This chamber is utilized for collecting and measuring the volume of positive ions ionized by Alpha particles, serving as indicators of radon gas levels. The main detection chamber comprises a semi-enclosed, plated plastic chamber. During operation, the conductive plated chamber wall is positively charged, while the center rod remains neutral. The center rod collects the positive charge from cations, which, under the influence of the positively charged chamber wall, migrate towards it. This setup enables the detection circuit on the printed circuit board (PCB) to measure the volume of positively charged ions and transmit the signal for further processing.

### BRIEF DESCRIPTION OF THE DRAWINGS

FIG. 1: Sectional view of a plastic semi-vented integrated design of radon detector. It shows an overall structure of the detector. It includes a PCB module, FFRC connector attached to the PCB module, a center rod for collection of ionized positive charge, the conductive coated plastic chamber with guided air flow holes on the wall and a semi-vented and integrated bottom enclosure.

FIG. 2: Bottom view of the detector. The bottom of the detector is a vented semi-enclosed ion chamber bottom side with air inlet holes.

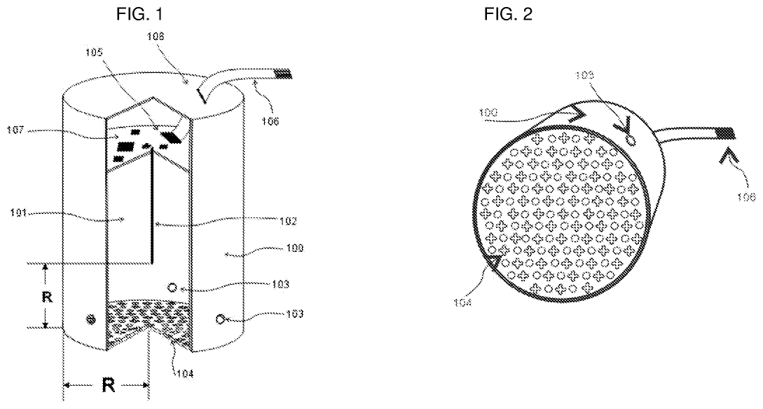

### DETAILED DESCRIPTION

The present invention relates to a radon gas detector featuring integrated collection 100 and processing functionality 107 within a semi-enclosed, injection-mold produced and plated plastic vented ion chamber. Radon gas, a hazardous substance, is known to emanate from soil and building materials, posing significant health risks when accumulated indoors. Hence, effective detection and measurement of radon gas levels are imperative for maintaining indoor air quality and ensuring occupant safety.

The disclosed detector addresses these concerns by leveraging a novel design incorporating plastic materials for the ion chamber 100, streamlining manufacturing processes and reducing production costs. Central to its operation is conductive material coated plastic semi-enclosed ion chamber, meticulously engineered to capture and quantify positive generated by the ionization of Alpha particles emitted by radon gas. The detector's primary detection chamber comprises a semi-enclosed, conductive-plated plastic structure. During usage, a positive voltage is applied to the conductive plated chamber 101, while the center rod 102 remains electrically neutral. The center rod 102 functions as a collector for the positive charge carried by cations. The center rod one end is securely fastened to the internal printed circuit board (PCB), another end has a distance R to the chamber bottom wall. The R is the radius of the chamber body.

By exploiting the electric field established by the positively charged chamber wall, cations are compelled to migrate towards the center rod 102. This migration enables the detection circuit integrated into the printed circuit board (PCB) 107 to accurately measure the volume of positively charged ions, thereby facilitating precise determination of radon gas levels. The detector's compact design and efficient functionality make it suitable for deployment in various indoor environments, including residential, commercial, and industrial settings.

The chamber is equipped with guided gas flow holes located on its sides 103. These holes allow for the controlled passage of gas, ensuring uniform exposure to the sensing elements. The number of guided flow holes is not limited, providing flexibility in design and optimization.

The bottom side of the ion chamber features a vented semi-enclosed design 104, incorporating air inlet holes. This configuration allows for efficient airflow and gas exchange, facilitating the detection process.

An integrated printed circuit board (PCB) 107 is housed within the chamber for preprocessing the signals captured by the center rod. This onboard circuitry enhances signal processing capabilities, optimizing the detector's performance. For signal output and communication via a Flat Flex Ribbon Cable (FFRC) 106 and it connected to an in-chamber FFRC connector 105. This connector enables seamless integration with external devices and systems, ensuring reliable data transmission.

To mitigate external electrical noise interference, the top side of the ion chamber is enclosed and coated with a conductive material 108.

In summary, the disclosed radon gas detector represents a significant advancement in the field of indoor air quality monitoring. By combining collection and processing functionalities within a plastic vented ion chamber, the detector offers enhanced accuracy, affordability, and ease of manufacturing, thereby addressing critical concerns associated with radon gas detection and mitigation.

1. A radon gas detector comprising a 2-in-1 structure of an injection-molded and plated plastic semi-enclosed ion chamber, wherein said detector integrates collection and processing functionalities within a single unit. The ion chamber is manufactured using injection molding techniques.

2. The radon gas detector of claim 1, wherein the center conductive rod 102 is securely fastened on the internal PCB. Inside the chamber, a central conductive rod is placed for collecting ionized positive charge.

3. The radon gas detector of claim 1, wherein the guided gas flow holes 103 on the side of the chamber.

4. The radon gas detector of claim 1, wherein the enclosed chamber bottom side with air inlet holes 104.

5. The radon gas detector of claim 1, wherein the in-chamber FFRC (Flat Flex Ribbon Cable) connector 105 is used for signal output cable connection.

6. The radon gas detector of claim 1, wherein the in-chamber circuit PCB assembly module for preprocessing the signal with the center rod.

7. The radon gas detector of claim 1, wherein the 100% enclosed ion chamber top side to prevent electric noise from outside of chamber.

8. The radon gas detector of claim 1, wherein the double layered anti-noise layers, which is inner and outer coated conductive material to prevent noise from outside.

9. The radon gas detector of claim 1, wherein the distance R from the chamber center rod tip to the bottom wall is the radius of the chamber.

10. The radon gas detector of claim 1, wherein the chamber is an injection mode produced.

11. The radon gas detector of claim 1, wherein the chamber is a plated chamber.

12. The radon gas detector uses Flat Flex Ribbon Cable (FFRC) 106 for signal output. The Flat Flex Ribbon Cable is for signal communication connection.
